(19) United States
(12) Patent Application Publication
(10) Pub. No.: US 2025/0255427 A1
(43) Pub. Date: Aug. 14, 2025

(54) OVERFLOW PREVENTION APPARATUS

(71) Applicant: Ken Clayton, Krum, TX (US)

(72) Inventor: Ken Clayton, Krum, TX (US)

(21) Appl. No.: 18/439,929

(22) Filed: Feb. 13, 2024

(51) Int. Cl. A47J 27/56; F04D 25/06; F04D 25/08; F04D 29/02; F04D 29/60

(52) U.S. Cl. CPC A47J 27/56; F04D 25/0673; F04D 25/08; F04D 29/601; F04D 29/023

(57) ABSTRACT

An overflow prevention apparatus for blowing air toward a boiling liquid to burst bubbles formed while boiling the liquid includes a housing. A fan is rotatably mounted on the housing, and a motor is mounted in the housing. The motor is operably coupled to the fan, which is configured urge air away from the housing when rotated. A support is coupled to and extending away from the housing and is configured to adjust a position of the fan with respect to a distal end of the support with respect to the housing. A clamp is mounted to the distal end of the support with respect to the housing and is operable to alternately open and close a pair of jaws of the clamp.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to overflow prevention apparatuses and more particularly pertains to a new overflow prevention apparatus for blowing air toward a boiling liquid to burst bubbles formed while boiling the liquid.

### (2) Description of Related Art Including Information Disclosed Under 37 CFR 1.97 and 1.98

The prior art discloses various overflow prevention apparatuses which blow air toward a boiling liquid to burst bubbles formed while boiling the liquid. However, the prior art fails to describe such an apparatus which clips to the pot holding the liquid, urges air in a diffuse manner toward the liquid, and comprises silicone fan blades to prevent damage from heat to the fan. The prior art also fails to disclose a method of preventing liquids from boiling over which includes mounting a such an overflow prevention apparatus at a farthest end of a handle of the pot to prevent heat damage to the connector.

### BRIEF SUMMARY OF THE INVENTION

An embodiment of the disclosure meets the needs presented above by generally comprising a housing. A fan is rotatably mounted on the housing, and a motor is mounted in the housing. The motor is operably coupled to the fan, which is configured urge air away from the housing when rotated. A support is coupled to and extending away from the housing and is configured to adjust a position of the fan with respect to a distal end of the support with respect to the housing. A clamp is mounted to the distal end of the support with respect to the housing and is operable to alternately open and close a pair of jaws of the clamp.

Another embodiment of the disclosure includes a method of preventing liquids from boiling over a rim of a pot. The method comprises fixing an overflow prevention apparatus with respect to the pot and directing a fan of the overflow prevention apparatus toward a liquid contained in the pot. The pot is heated such that the liquid boils and forms bubbles of the liquid at a surface of the liquid. The fan is rotated via a motor or the like to urge air toward the bubbles, thereby bursting the bubbles before they expand and overflow over the rim of the pot.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of an overflow prevention apparatus according to an embodiment of the disclosure.

FIG. 2 is a bottom perspective view of an embodiment of the disclosure.

FIG. 3 is a side view of an embodiment of the disclosure.

FIG. 4 is a detail view of an embodiment of the disclosure taken from Window 4 in FIG. 3.

FIG. 5 is a side in-use view of an embodiment of the disclosure.

FIG. 6 is a perspective in-use view of an embodiment of the disclosure.

### DETAILED DESCRIPTION OF THE INVENTION

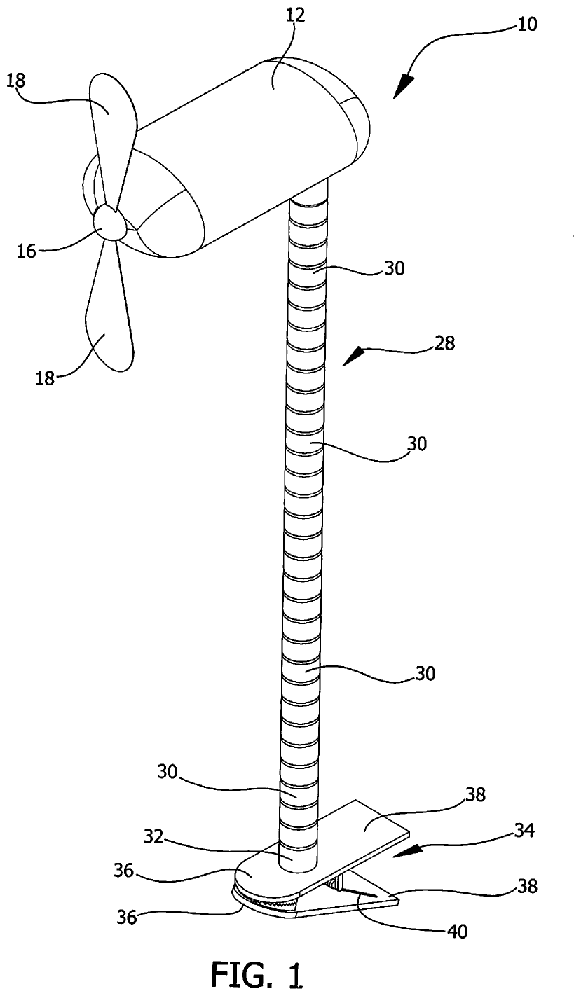

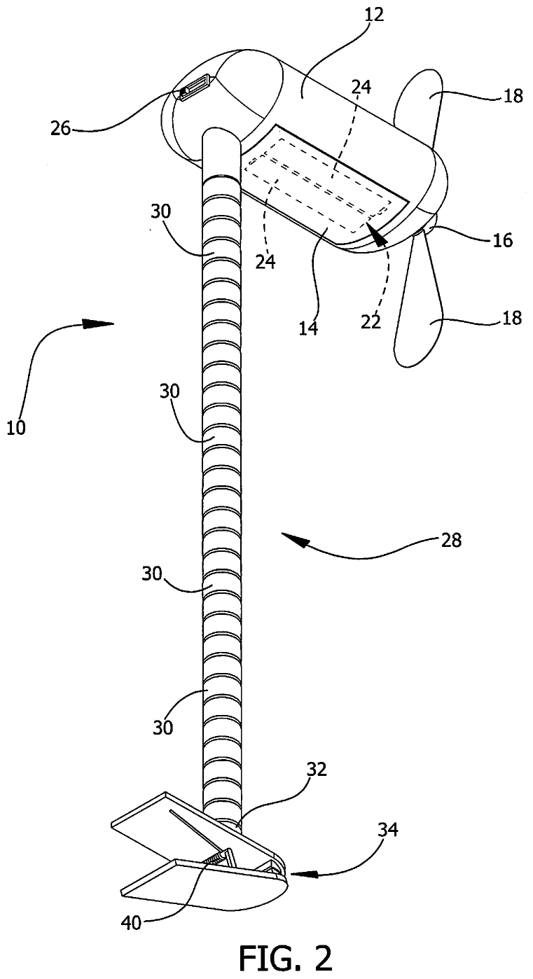

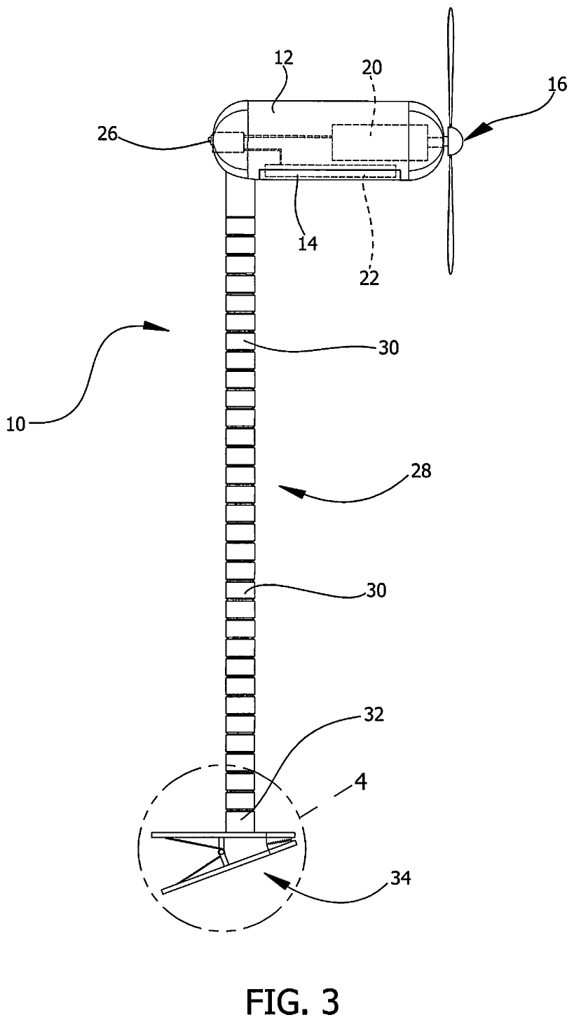

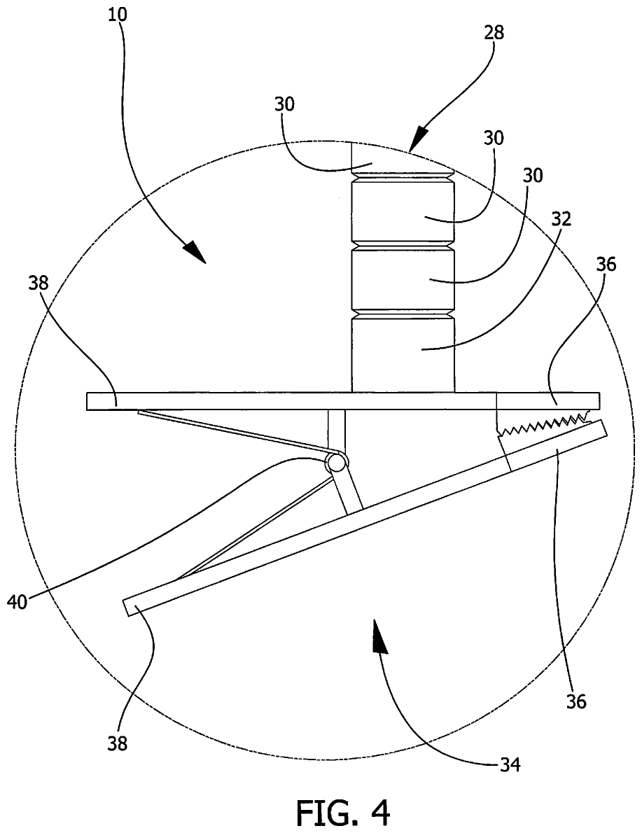

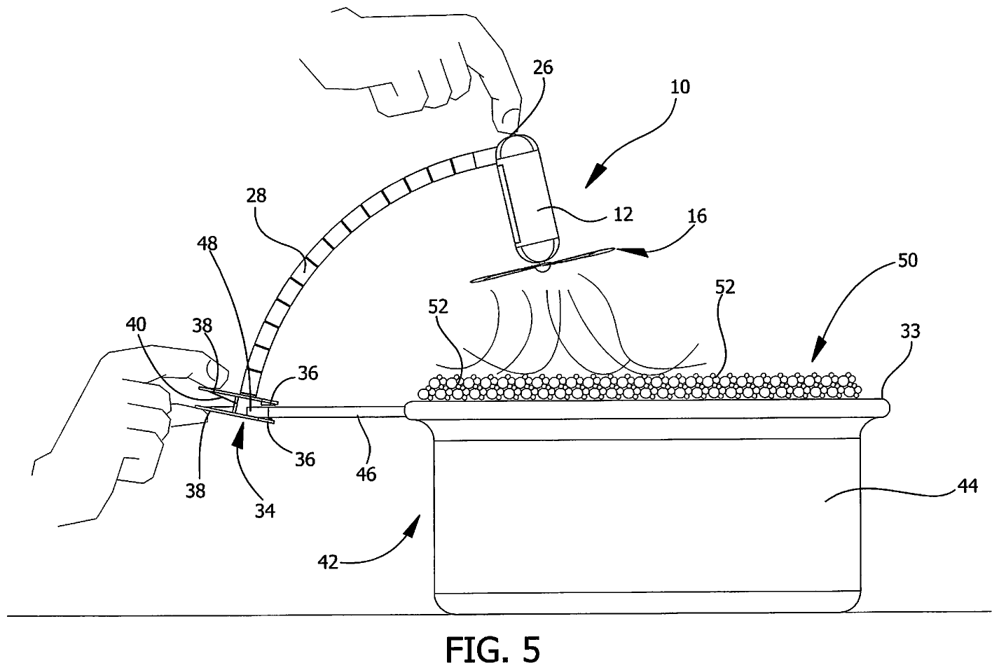

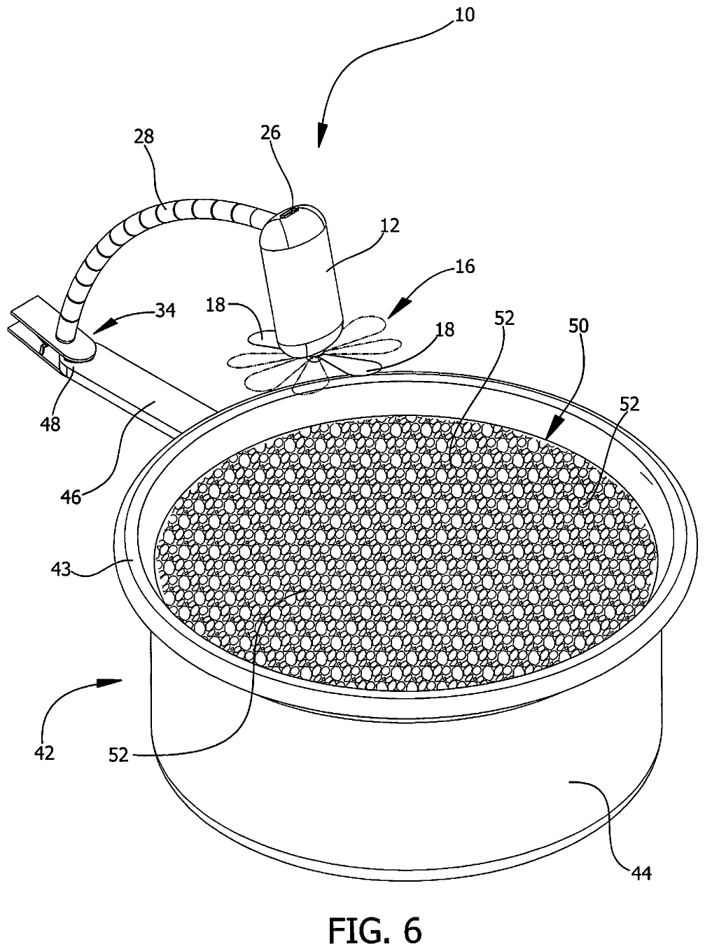

With reference now to the drawings, and in particular to FIGS. 1 through 6 thereof, a new overflow prevention apparatus embodying the principles and concepts of an embodiment of the disclosure and generally designated by the reference numeral 10 will be described.

As best illustrated in FIGS. 1 through 6, the overflow prevention apparatus 10 generally comprises a housing 12. A fan 16 is rotatably mounted on the housing 12 and is configured to urge air away from the housing 12 when rotated. The fan 16 comprises a plurality of blades 18 which are radially arranged. When the fan 16 is rotated, the blades 18 urge air away from the housing 12 in a diffuse fashion. A motor 20 is mounted in the housing 12 and is operably coupled to the fan 16. A power supply 22 is mounted in the housing 12 and is selectively electrically coupled to the motor 20. The power supply 22 comprises a battery 24 but may comprise a capacitor or any other suitable power source. The housing 12 includes an access door 14 which may open to facilitate access to the power supply 22. In other embodiments, the motor 20 may selectively electrically couple to an external power source such as via an electrical outlet. A switch 26 is electrically coupled to the power supply 22 and the motor 20 and is operable to selectively electrically couple the power supply 22 to the motor 20 to activate the motor 20.

A support 28 is coupled to and extends away from the housing 12. The support 28 is bendable and is configured to maintain a shape until acted upon by a sufficient bending force. The support 28 comprises a plurality of articulated segments 30 which retain their relative positions via friction until the sufficient bending force is applied. In other embodiments, the support 28 may comprise a malleable material which is sufficiently rigid to maintain its shape when not acted upon by the sufficient bending force.

A clamp 34 is mounted to a distal end 32 of the support 28 with respect to the housing 12. The clamp 34 is operable to alternately open and close a pair of jaws 36 of the clamp 34 and is biased to close. The jaws 36 are pivotably coupled to each other, and each jaw 36 has one of a pair of grips 38 attached thereto. The grips 38 are movable toward each other to pivot open the jaws 36. A torsion spring 40 engages the grips 38 to bias them apart from each other and close the jaws 36. Other types of springs or other biasing members may be used in other embodiments to bias the clamp to open.

The blades 18 of the fan 16 and the jaws 36 of the clamp 34 comprise a heat resistant material such that heat damage is resisted when the fan 16 and the clamp 34 are positioned near boiling liquid or against a pot 42 as the pot 42 is heated. The heat resistant material comprises silicone but may comprise any suitable material.

In use, the overflow prevention apparatus 10 is attached to the pot 42 via the clamp 34. Preferably, the clamp 34 is closed around a farthest end 48 of a handle 46 of the pot 42 with respect to a body 44 of the pot 42. Heat damage to the clamp 34 is thereby minimized by keeping the clamp 34 spaced from the body 44 of the pot 42 when it is heated by a stove, a hot plate, or the like. The support 28 is adjusted to direct the fan 16 toward a liquid 50 contained in the pot 42 and set the fan 16 at a desirable distance from the liquid 50. The body 44 of the pot 42 is heated to cause the liquid 50 to boil, thus forming bubbles 52 of the liquid 50 at surface thereof. The fan 16 is operated via activating the motor 20 to urge air against the bubbles 52, thereby causing the bubbles 52 to burst before they rise over a rim 43 of the pot 42. The fan 16 urges the air diffusely against the liquid 50 in order to cause bubbles 52 throughout the interior of the pot 42 to burst. This action is in contrast to other devices in which a tube or other concentrated blowing means creates a jet of air that may only burst bubbles 52 in a relatively smaller area.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An overflow prevention apparatus for preventing liquids from boiling over a rim of a pot, the apparatus comprising:
a housing;
a fan rotatably mounted on the housing, the fan being configured to urge air away from the housing when rotated;
a motor mounted in the housing and operably coupled to the fan;
a support coupled to and extending away from the housing, the support being configured to adjust a position of the fan with respect to a distal end of the support with respect to the housing; and
a clamp being mounted to the distal end of the support with respect to the housing, the clamp being operable to alternately open and close a pair of jaws of the clamp.

2. The apparatus of claim 1, wherein the fan being configured to urge air in a diffuse fashion when rotated.

3. The apparatus of claim 1, wherein the fan comprises a plurality of blades which are radially arranged.

4. The apparatus of claim 3, wherein the blades comprise a heat resistant material.

5. The apparatus of claim 4, wherein the heat resistant material comprises silicone.

6. The apparatus of claim 1, further comprising:
a power supply mounted in the housing and selectively electrically coupled to the motor; and
a switch electrically coupled to the power supply and the motor, the switch being operable to selectively electrically couple the power supply to the motor to activate the motor.

7. The apparatus of claim 6, wherein the power supply comprises a battery.

8. The apparatus of claim 1, wherein the support is bendable, the support being configured to maintain a shape until acted upon by a sufficient bending force.

9. The apparatus of claim 1, wherein the jaws of the clamp are biased to close.

10. The apparatus of claim 1, wherein the jaws comprise a heat resistant material.

11. The apparatus of claim 1, wherein pair of jaws are pivotably coupled to each other, the clamp comprising a pair of grips, each grip being coupled to a respective one of the pair of jaws, the grips being movable toward each other to open the jaws, the clamp comprising a torsion spring which engages the grips to bias them apart from each other and to bias the jaws to close.

12. An overflow prevention apparatus for preventing liquids from boiling over a rim of a pot, the apparatus comprising:
a housing;
a fan rotatably mounted on the housing, the fan being configured to urge air away from the housing when rotated, the fan being configured to urge air in a diffuse fashion when rotated, the fan comprising a plurality of blades which are radially arranged, the blades comprising a heat resistant material;
a motor mounted in the housing and operably coupled to the fan;
a power supply mounted in the housing and selectively electrically coupled to the motor, the power supply comprising a battery;
a switch electrically coupled to the power supply and the motor, the switch being operable to selectively electrically couple the power supply to the motor to activate the motor;
a support coupled to and extending away from the housing, the support being bendable, the support being configured to maintain a shape until acted upon by a sufficient bending force; and
a clamp being mounted to a distal end of the support with respect to the housing, the clamp being operable to alternately open and close a pair of jaws of the clamp, the jaws of the clamp being biased to close, the jaws comprising the heat resistant material, the pair of jaws being pivotably coupled to each other, the clamp comprising a pair of grips, each grip being coupled to a respective one of the pair of jaws, the grips being movable toward each other to open the jaws, the clamp comprising a torsion spring which engages the grips to bias them apart from each other and to bias the jaws to close.

13. A method of preventing liquids from boiling over a rim of a pot, the method comprising:
fixing an overflow prevention apparatus with respect to the pot;
directing a fan of the overflow prevention apparatus toward a liquid contained in the pot;
heating the pot such that the liquid boils, thereby forming bubbles of the liquid at a surface of the liquid; and
rotating the fan, thereby urging air toward the bubbles to burst the bubbles.

14. The method of claim 13, wherein the step of fixing the overflow prevention apparatus with respect to the pot includes securing the overflow prevention apparatus to the pot via a clamp.

15. The method of claim 14, wherein the clamp comprises jaws having a heat resistant material.

16. The method of claim 14, wherein the step of fixing the overflow prevention apparatus with respect to the pot further includes attaching the clamp to a farthest end of a handle of the pot with respect to a body of the pot, thereby minimizing heat damage to the clamp due to contact with the pot.

17. The method of claim 13, wherein the fan is configured to urge air in a diffuse fashion when rotated.

18. The method of claim 13, wherein the fan comprises a heat resistant material.

19. The method of claim 13, wherein the step of directing the fan toward the liquid further comprises adjusting a support of the overflow prevention apparatus.
